(19) United States
(12) Patent Application Publication
(10) Pub. No.: US 2011/0262887 A1
(43) Pub. Date: Oct. 27, 2011

(54) SYSTEMS AND METHODS FOR GAZE BASED ATTENTION TRAINING

(75) Inventor: Dixon Cleveland, Annandale, VA (US)

(73) Assignee: LC Technologies Inc.

(21) Appl. No.: 13/089,791

(22) Filed: Apr. 19, 2011

Related U.S. Application Data
(60) Provisional application No. 61/326,360, filed on Apr. 21, 2010.

(51) Int. Cl. G09B 19/00

(52) U.S. Cl. 434/247

(57) ABSTRACT

Gaze based systems and methods are used to monitor the attention of a user. One or more images are displayed to a user on a display. It is determined that an image of the one or more images is being viewed by an eye of the user from one or more measurements received from an eyetracker. One or more modifications to the image are displayed on the display over time so as to maintain the attention of the user. Whether or not the attention of the user is maintained is determined from one or more additional measurements received from the eyetracker after the one or more modifications to the image. In various embodiments, the one or more modifications to the image include moving the image on the display. In various embodiments, the one or more modifications to the image include animating the image on the display.

### CROSS-REFERENCE TO RELATED APPLICATION

This application claims the benefit of U.S. Provisional Patent Application No. 61/326,360, filed Apr. 21, 2010, which is incorporated by reference herein in its entirety.

### BACKGROUND OF THE INVENTION

1. Field of the Invention

Embodiments of the present invention relate to systems and methods for gaze based attention training More particularly, various embodiments relate to systems and methods that a) monitor a person's gaze activity as he interacts with a dynamic, computer-generated environment, b) observe when the person is paying attention and what he is paying attention to, and c) adaptively modify the environment's activity to encourage and teach the person to maintain visual attention and to reinforce positive visual attention behaviors.

2. Background Information

The human brain has a highly sophisticated process for choosing where to point our eyes. We have a natural instinct to look at what we are most interested in. At any given time, we point our eyes at what we (at some basic cognitive level) perceive will provide us with the most important or relevant information about what is of interest to us at the time. For example, when placed in a new environment, our brain's natural behavior is to scan the new scene to make a general assessment of what is relevant, and then to look with more detail at what is most important or interesting. This “scan then concentrate” process is a fundamental, innate visual behavior that we execute continually in the process of interacting with our environment. Our visual scan patterns are highly indicative of our brain's attention process.

### BRIEF DESCRIPTION OF THE DRAWINGS

The skilled artisan will understand that the drawings, described below, are for illustration purposes only. The drawings are not intended to limit the scope of the present teachings in any way.

FIG. 1 is a block diagram that illustrates a computer system, in accordance with various embodiments.

FIG. 2 is a schematic diagram showing an eyetracker, in accordance with various embodiments.

FIG. 3 is a schematic diagram of a system for monitoring the attention of a user, in accordance with various embodiments.

FIG. 4 is flowchart showing a method for monitoring the attention of a user, in accordance with various embodiments.

FIG. 5 is a schematic diagram of a system that includes one or more distinct software modules that performs a method for monitoring the attention of a user, in accordance with various embodiments.

Before one or more embodiments of the present teachings are described in detail, one skilled in the art will appreciate that the present teachings are not limited in their application to the details of construction, the arrangements of components, and the arrangement of steps set forth in the following detailed description or illustrated in the drawings. Also, it is to be understood that the phraseology and terminology used herein is for the purpose of description and should not be regarded as limiting.

### DESCRIPTION OF VARIOUS EMBODIMENTS

### Computer-Implemented System

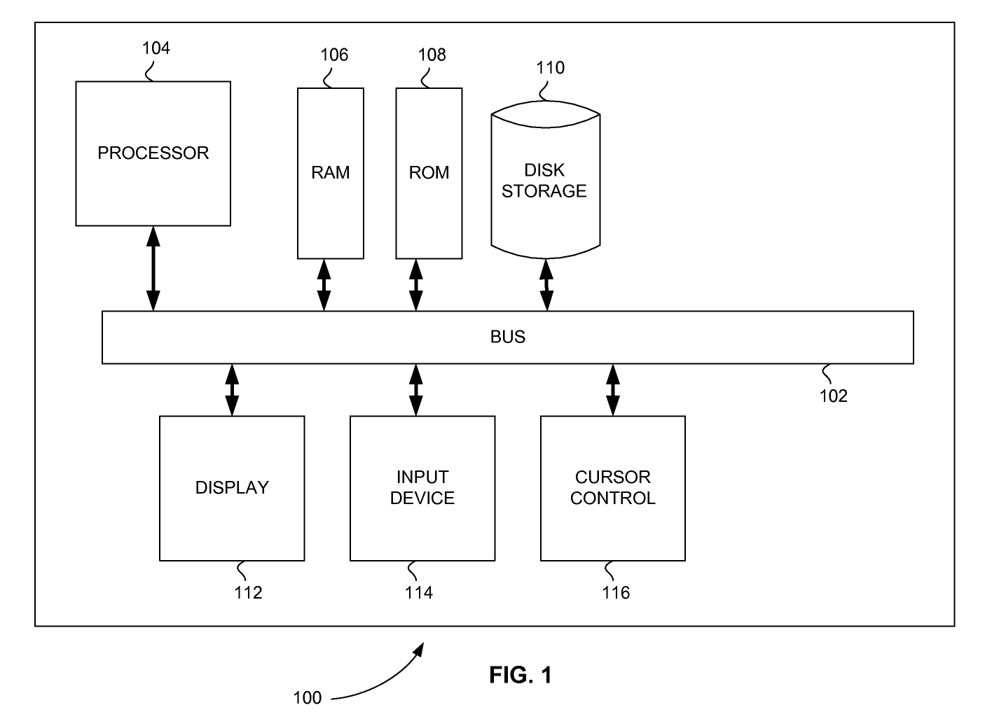

FIG. 1 is a block diagram that illustrates a computer system 100, in accordance with various embodiments. Computer system 100 includes a bus 102 or other communication mechanism for communicating information, and a processor 104 coupled with bus 102 for processing information. Computer system 100 also includes a memory 106, which can be a random access memory (RAM) or other dynamic storage device, coupled to bus 102 for determining base calls, and instructions to be executed by processor 104. Memory 106 also may be used for storing temporary variables or other intermediate information during execution of instructions to be executed by processor 104. Computer system 100 further includes a read only memory (ROM) 108 or other static storage device coupled to bus 102 for storing static information and instructions for processor 104. A storage device 110, such as a magnetic disk or optical disk, is provided and coupled to bus 102 for storing information and instructions.

Computer system 100 may be coupled via bus 102 to a display 112, such as a cathode ray tube (CRT), liquid crystal display (LCD), or 3-dimensional display, for displaying information to a computer user. An input device 114, including alphanumeric and other keys, is coupled to bus 102 for communicating information and command selections to processor 104. Another type of user input device is cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results are provided by computer system 100 in response to processor 104 executing one or more sequences of one or more instructions contained in memory 106. Such instructions may be read into memory 106 from another computer-readable medium, such as storage device 110. Execution of the sequences of instructions contained in memory 106 causes processor 104 to perform the process described herein. Alternatively hard-wired circuitry may be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium may take many forms, including but not limited to, non-volatile media, volatile media, and transmission media. Non-volatile media includes, for example, optical or magnetic disks, such as storage device 110. Volatile media includes dynamic memory, such as memory 106. Transmission media includes coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible medium from which a computer can read.

Various forms of computer readable media may be involved in carrying one or more sequences of one or more instructions to processor 104 for execution. For example, the instructions may initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 carries the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a non-transitory and tangible computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

The following descriptions of various implementations of the present teachings have been presented for purposes of illustration and description. It is not exhaustive and does not limit the present teachings to the precise form disclosed. Modifications and variations are possible in light of the above teachings or may be acquired from practicing of the present teachings. Additionally, the described implementation includes software but the present teachings may be implemented as a combination of hardware and software or in hardware alone. The present teachings may be implemented with both object-oriented and non-object-oriented programming systems.

### Eyetracker

In general, an eyetracker is a device that is used to determine where an eye is looking Modern eyetrackers, sometimes referred to as video eyetrackers, are camera-based devices that observe a person's eyes and predict the point in space where the person is looking This point in space is referred to as the gazepoint, for example. The line connecting the fovea of the eye, the center of the eye pupil, and the gazepoint is referred to as the gazeline, for example.

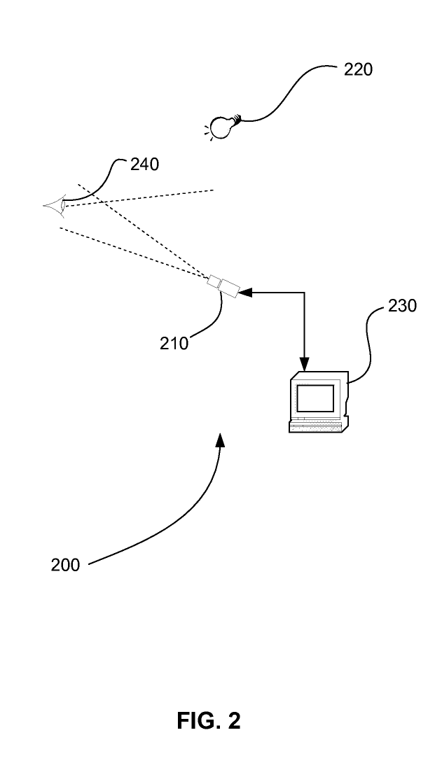

FIG. 2 is a schematic diagram showing an eyetracker 200, in accordance with various embodiments. Eyetracker 200 includes camera 210, illumination source 220, and processor 230. Illumination source 220 illuminates eye 240, and camera 210 images eye 240. Processor 230 receives the image from camera 210 and determines the position of eye 240 from the image. Eyetracker 200 can include additional elements. For example, eyetracker 200 can include one or more additional cameras (not shown) or one or more additional optical devices (not shown) to determine the range from camera 210 to eye 240. Eyetracker 200 can also include a display (not shown) to determine the gazepoint in an image displayed by processor 230 on the display.

### Systems and Methods of Data Processing

### Utilizing Natural Gaze Activity

As described above, when placed in a new environment, the human brain's natural behavior is to scan the new scene and then look with more detail at what is most important, relevant, or interesting to us at the time. This “scan then concentrate” process appears to be important in maintaining the brain's attention or focus.

In various embodiments, systems and methods that exploit the “scan then concentrate” process are used to maintain a subject's attention. Such systems and methods can be used as a therapeutic or diagnostic tool for attention disorders. For example, such systems or methods can be used as a therapeutic or diagnostic tool in autism. Although the particulars of the “scan then concentrate” process may be different for autistic and non-autistic children, the fundamental process is basically the same for both populations.

In various embodiments, systems and methods that exploit the “scan then concentrate” process are used in interacting with autistic children. For a child to learn, it is essential that he is paying attention to the subject matter. Systems and methods are provided that encourage autistic children to maintain visual attention while learning to perform skill-based tasks. These systems and methods are developed to detect the visual attention of autistic children and reward them for their visual attention.

In various embodiments, feedback from eyetracker measurements is used to encourage and teach autistic children to maintain visual attention to a task. For example, an autistic student can unconsciously perform a visual scan of the instruments displayed on a display. He then concentrates his vision toward the instrument of greatest interest to him.

When an eyetracker observes what the student is looking at most, the system can automatically respond with a related activity that is interesting and teaches a lesson. Thus the system provides a highly responsive environment that encourages student exploration, learning, and interaction. The utilization of eyetracking allows the system to respond almost directly to the user's thoughts alone, without the student having to take volitional manual action.

Gaze Based Pedagogies for Children with Autism

In various embodiments, a gaze based system for attention monitoring or training includes an eyetracker, a display, and a computer system. For example, a plurality of images is presented to a child on the display. A video camera of the eyetracker, mounted below the display, passively observes the child's eyes as he/she interacts with the images on the display. Based on the camera's video image of the student's eyes, the eyetracker provides continuous feedback as to where on the screen the student is looking.

The plurality of images on the screen can start as static objects on the display. In a music pedagogy, for example, the initial display may consist of several musical instruments. At first, the student might not look at the screen at all, or may look around at all the different instruments. When, however, he looks at one of the instruments long enough to indicate a potential interest in it, the eyetracker detects the visual attention, and the instrument “wakes up” and begins to play a song. If the student continues to watch the instrument, its activity continues to grow. Next, the image of the instrument slowly expands and takes over the full screen, while the other instruments slowly disappear. And with further attention, the selected instrument becomes animated, perhaps showing how it works mechanically as it plays the song.

Initially, the student is not required to execute any manual activity, such as manipulating a mouse, pressing a key, or handling the instrument. All he has to do is look at an object on the screen to make something happen. His natural eye activity is enough to elicit a response. The display provides an interesting, interactive environment, and the student's natural instinct to look at things is enough to activate those objects. The objective is for the student to learn, albeit unconsciously at first, that his eyes' natural search activity generates a response from the system.

The system responds to the student's natural visual activity and requires little or no conscious manual initiative. In various embodiments, the system can incorporate manual interaction into the pedagogy, including activities such as mousing, typing, playing the instrument with his eyes, or even playing a physical instrument manually. For example, the student can play the keys on a plano image simply by looking at them, or he may play a physical keyboard connected to the computer.

### Pedagogical Goals

In various embodiments and to achieve the pedagogical goals, the systems and methods described herein can include event scenarios that attract the student's attention, teach them relevant information, and maintain their attention long enough to support deeper learning through repetition, practice and ever increasing task complexity.

Such systems and methods encourage visual attention to a learning task. As long as the student is watching, his continued visual attention is rewarded by sustained or increased object activity. Such activities may include, for example, a transformation in the object's appearance, object motion, object animation, or the object making sound. In the music example, an instrument may become animated and begin to play music, and more of the physical features of the instrument may be displayed. On the other hand, if the student looks away for too long, the activity “fades out” and eventually ceases. In the music example, the screen image may gradually revert all the way back to the original screen showing several static instruments. The student learns that continued visual attention sustains enjoyable activity.

In various embodiments, systems and methods modulate the complexity of objects or activities as a function of gaze attention. In the music example, the instrument may increase the level of complexity and excitement by modifying the rhythm, richness, or content of the music being played in response to the gaze attention. Or the system may display increasing detail on how the instrument is played, by adding images of a player's hands and showing the instrument's fingering operations. The system rewards continued visual attention with increased learning information on how the instrument is used.

In various embodiments, topics of particular interest to the student are selected, without the student having to consciously choose a topic and manually activate his choice. In the above music example, for instance, the systems and methods might display a number of instruments, such as a piano, saxophone, and guitar, and allow the student to select the instrument of choice simply by looking at it. The student's gaze naturally and unconsciously goes to the instrument of his greatest interest. If the student pays more visual attention to the guitar than the other two instruments, the guitar may begin to play by itself, or play the lead role in a song. The eyetracker observes the student's gaze pattern as he looks at the screen, and the systems and methods automatically infer his current instrument of interest. Note that to make this choice of instrument, the student is not distracted by the requirements to make a mindful selection and then to activate his choice with a verbal response, the pointing of a mouse cursor, or the press of a button. Since he is able to make the choice with his natural eye activity alone, it is easier for him to continue to pay attention to the music itself, rather than to a method for selecting the music he wants.

### Autism

In various embodiments, therapeutic or diagnostic system and methods are directed to children with autism. Since such systems and methods are oriented around visual displays, it takes advantage of autistic children's preferences toward visual stimulation. For autistic children who perseverate, such systems and methods attempt to turn this behavior to advantage by having the activities grow in complexity as the student repeats them. Finally, such systems and methods attract attention to learning environments while minimizing direct social interaction with their teachers and avoiding the use of language and verbal communications.

In various embodiments, such systems and methods minimize the requirement for interpersonal interaction. The topics that the systems and methods teach can support the ultimate development of social skills. The music pedagogy discussed above, for example, addresses the development of a skill set that can help an autistic student feel more comfortable with other students who have an interest in music. Without music knowledge, he may feel unacceptable to the group. With the knowledge, he may be more confident in joining the group.

In various embodiments, systems and methods are developed to cover a broad range of topics, including academics, arts, sciences, sports, games, and social situations. The above music pedagogy is just one example. In all cases, graphics, sounds, and activities of the systems and methods are designed to attract the autistic child into an enticing, fully immersive environment.

In various embodiments, systems and methods are used to simulate social situations directly. For example, characters are generated who talk, respond with facial expressions, and make eye contact with the student. With the eyetracker equipment monitoring the student's eye activity, the simulated characters can respond to the student's visual interactions with their own eye activity—looking directly back at the student when the student looks at them, periodically glancing away, and looking away when the student is not paying attention to them. The simulated characters can even encourage the autistic child to interact with real people.

### Teacher Interaction

Though minimizing direct social interaction with teachers may help autistic children learn (particularly in the early phases), it is critical to keep teachers involved in the learning process from the start. In various embodiments, a teacher participates in systems and methods via a separate display and console. The teacher console shows the same display the student sees, but has several additional features.

First, the teacher's display shows the teacher where the student is looking—displaying a trace of the last several seconds of the students gaze superimposed on his copy of the student display. Thus the teacher can see directly what the student is paying attention to at any time—without the distraction of the teacher observing the child's eyes directly. In fact, the teacher is not required to interact physically or socially with the child at all.

Secondly, the teacher console provides a set of controls that allow him to interact with, adjust or override the system or method's gaze-driven operation. For example, the teacher can manually navigate through a pedagogy without requiring the student's visual interaction, pause and resume operation, adjust the sets of alternative selections that the student may make (such as the list of musical instruments), and set the responses (such as which songs to play, or how loud to play them).

Though it is possible for a teacher to interact with the student through an interface without direct physical or social interaction, physical or social interaction is not ruled out. When desired, the teacher is free to set up his work station right next to the child, point to objects on the child's screen, talk to him, and personally interact with him.

### Attention Assessment

In various embodiments, a gaze-based feedback mechanism provides a teacher with behavioral information that is used to monitor and assess the child's evolving ability and desire to pay attention. During the work sessions, the display video with the gaze superimposed is recorded, providing a permanent record of the students' progress and allowing after-the-fact review and analysis. Performance measures such as the percentage of time the student looked at the screen as a whole, what objects he looked at most, and how his visual attention moved between different objects are also computed. The patterns of these gaze behaviors may be evaluated over successive sessions to assess the student's progress in paying visual attention.

### Gaze-Based Presentation Timing

The rate that information is presented to a student has a significant impact on the efficacy of his learning. If the information comes too fast, the student gets overwhelmed and confused. If the information comes too slow, he gets bored. In either case, the resulting frustration decreases the student's learning effectiveness and attention span. On the other hand, if the presentation rate is good, the student's learning is effective, his satisfaction is maximized, and his attention span is increased.

Optimum material presentation rate varies with a multitude of factors, including what the student already knows, his level of interest in the topic, and his current mood. A good human teacher is able to accommodate many of these variables. He looks for expressional clues from his student to determine when the student is ready for the next piece of information. When not ready, a student often looks away, indicating that he is still processing a prior chunk of information—or that his mind is elsewhere. His gaze often returns when he is cognitively ready for the next step.

In various embodiments, systems and method use eyetracking equipment to adapt presentation timing to the student's optimum learning rate. By observing what the student is doing with his eyes, the performance of a good teacher is mimicked and when the student is best ready for the next piece of information is inferred. In other words, the presentation of material to the student is timed based on his current gaze behavior, so he is exposed to new information when he is most receptive to learning it.

### Attention Monitoring System

Traditionally, a gaze contingent display utilizing an eyetracker has allowed a user to make selections on the display based on their eye movements. Such a system can provide feedback to the user by highlighting images that are located at the user's gazepoint as the user scans the display. Essentially, in such a system images on the display are highlighted or modified in response to or as a result of the user's eye movements. In other words the modification of the image follows the position in time or space of the gaze of the eye.

In various embodiments, systems are provided that modify images on a display in order encourage users to move or maintain the gaze of their eyes. In other words, the position in time or space of the gaze of the eye follows the modification of the image. Such systems can be used to monitor the attention of a user.

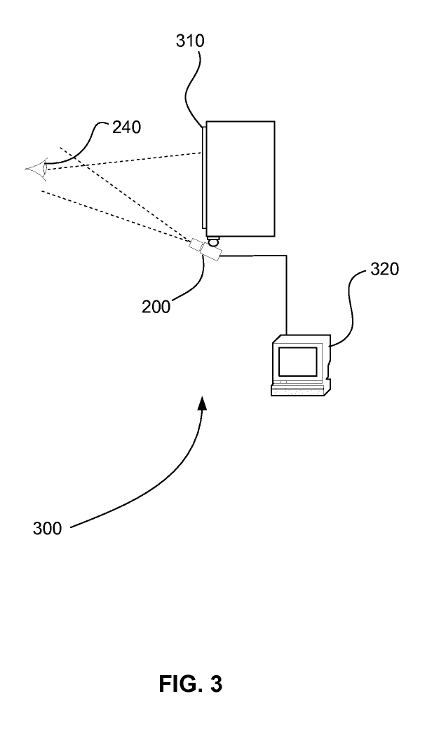

FIG. 3 is a schematic diagram of a system 300 for monitoring the attention of a user, in accordance with various embodiments. System 300 is used, for example, as a diagnostic or therapeutic tool for attention disorders such as autism. System 300 includes display 310, eyetracker 200, and processor 320. Display 310 can include, but is not limited to, a projector that displays an images on a screen or surface, a computer monitor, a television, a personal viewing device, a head mounted display, or any device capable of rendering images to eye 240 of a user. Display 310 can be a component of eyetracker 200, or display 310 can be a separate device. Eyetracker 200 measures the gazepoint of eye 240 of a user within display 310.

Processor 320 can include, but is not limited to, a computer system, a microprocessor, a microcontroller, an application specific integrated circuit (ASIC), a field programmable array (FPGA), or any electronic device capable of executing instructions, storing data, and communicating control and data information. Processor 320 can be a component of eyetracker 200, or processor 320 can be a separate device. Processor 320 is in communication with display 310 and eyetracker 200.

Processor 320 displays one or more images to the user on display 310. Processor 320 determines that an image of the one or more images is being viewed by eye 240 of the user from one or more measurements received from eyetracker 200. Processor 320 displays one or more modifications to the image on display 310 over time so as to maintain the attention of the user. Finally, processor 310 determines if the attention of the user is maintained from one or more additional measurements received from eyetracker 200 after the one or more modifications to the image.

In various embodiments, system 300 monitors the attention of a user by moving an image of interest to the user and determining if the gazepoint is maintained on the image. Processor 320 determines that an image of the one or more images is being viewed by eye 240 of the user from one or more measurements received from eyetracker 200 by receiving from eyetracker 200 a first gazepoint of eye 240 on display 310 and calculating the image that includes the first gazepoint. Processor 320 displays one or more modifications to the image on display 310 over time so as to maintain the attention of the user by displaying the image at a new location on display 310 so that the image does not include the location of the first gazepoint. Processor 320 determines if the attention of the user is maintained from one or more additional measurements received from eyetracker 200 after the one or more modifications to the image by receiving from eyetracker 200 a second gazepoint of eye 240 on display 310 after the image is modified and calculating if image includes the second gazepoint.

In various embodiments, system 300 monitors the attention of a user by animating an image of interest to the user and determining if the gazepoint is maintained on the image. Processor 320 displays one or more modifications to the image on display 310 over time so as to maintain the attention of the user by animating the image on display 310, for example. In various embodiments, processor 320 increases the activity of the animation if the attention of the user is maintained. In various embodiments, processor 320 decreases the activity of the animation if the attention of the user is not maintained.

In various embodiments, system 300 monitors the attention of a user by displaying additional details of the image of interest to the user and determining if the gazepoint is maintained on the image. Processor 320 displays one or more modifications to the image on display 310 over time so as to maintain the attention of the user by increasing the complexity of the image on display 310, for example.

In various embodiments, system 300 monitors the attention of a user by displaying the image of interest to the user with at least two modifications at two different times and determining if the gazepoint is maintained on the image at the two different times. The at least two modifications at two different times can include increasing the size of the image at two different times, for example.

In various embodiments, system 300 uses an input device (not shown) in addition to the eyetracker to monitor the attention of a user. Processor 320 displays another modification to the image on display 310 that encourages a response from the input device after the one or more modifications. Processor 320 determines that the user's attention is maintained, if the response from the input device is received. The input device can include, but is not limited to, a keyboard, a mouse, a head point, a finger pointer, or a microphone.

In various embodiments, the image that processor 320 determines is being viewed by eye 240 is a character with one or more eyes. The character is a person or an animal, for example.

In various embodiments, the image that processor 320 determines is being viewed by eye 240 is an eye of a character with one or more eyes. Processor displays one or more modifications to the image on display 310 over time so as to maintain the attention of the user by displaying the eye of the character as making eye contact with eye 240 of the user.

In various embodiments, system 300 further includes a second display (not shown). The second display allows a teacher to monitor activities of display 310 and eyetracker 200.

In various embodiments, system 300 further includes an input device (not shown) that allows the teacher to modify the image that processor 320 determines is being viewed by eye 240.

In various embodiments, system 300 further includes a memory (not shown) in communication with processor 320. Processor 320 uses the memory to record one or modifications to an image, the one or more measurements from eyetracker 200, the one or more additional measurements from eyetracker 200, and a rate of presentation of the one or modifications of the image to the user, for example. Processor 320 can also display one or more modifications of the image to the user based on a rate of presentation previously stored in the memory.

### Attention Monitoring Method

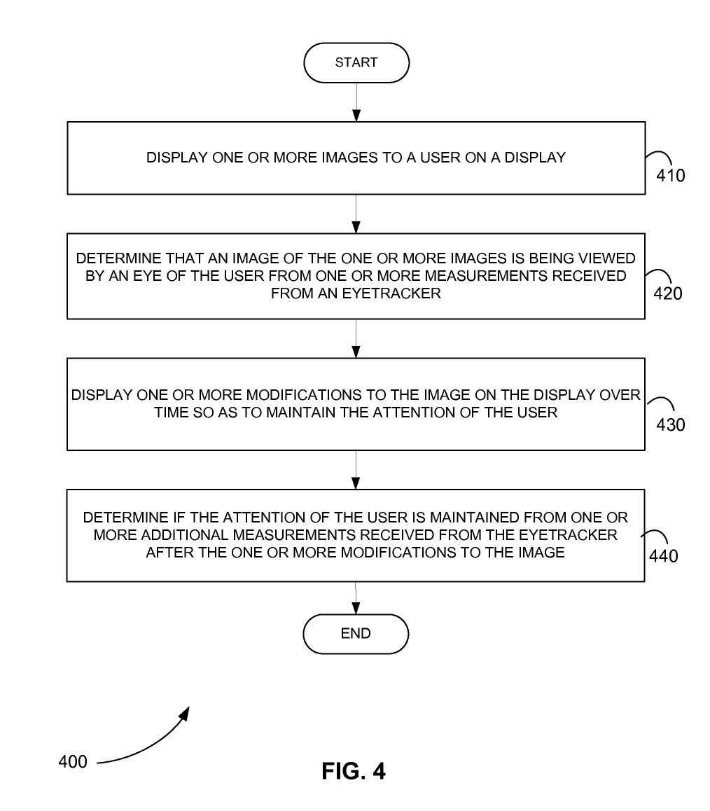

FIG. 4 is flowchart showing a method 400 for monitoring the attention of a user, in accordance with various embodiments.

In step 410 of method 400, one or more images are displayed to a user on a display.

In step 420, it is determined that an image of the one or more images is being viewed by an eye of the user from one or more measurements received from an eyetracker.

In step 430, one or more modifications to the image are displayed on the display over time so as to maintain the attention of the user.

In step 440, whether or not the attention of the user is maintained is determined from one or more additional measurements received from the eyetracker after the one or more modifications to the image.

### Attention Monitoring Computer Program Product

In various embodiments, a computer program product includes a non-transitory and tangible computer-readable storage medium whose contents include a program with instructions being executed on a processor so as to perform a method for monitoring the attention of a user. This method is performed by a system that includes one or more distinct software modules.

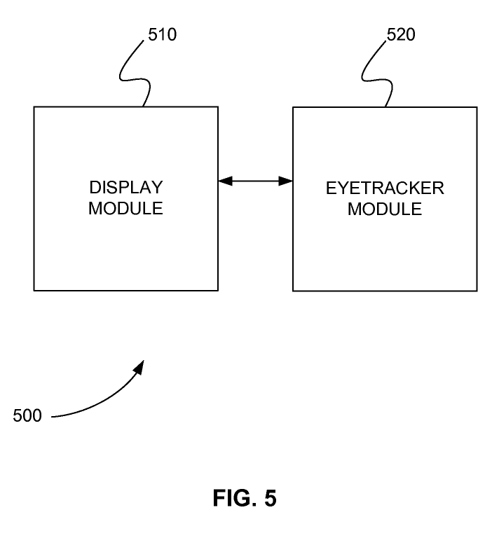

FIG. 5 is a schematic diagram of a system 500 that includes one or more distinct software modules that performs a method for monitoring the attention of a user, in accordance with various embodiments. System 500 includes display module 510 and eyetracker module 520.

Display module 510 displays one or more images to a user on a display. Eyetracker module 520 determines that an image of the one or more images is being viewed by an eye of the user from one or more measurements received from an eyetracker. Display module 510 displays one or more modifications to the image on the display over time so as to maintain the attention of the user. Finally, eyetracker module 520 determines if the attention of the user is maintained from one or more additional measurements received from the eyetracker after the one or more modifications to the image.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

What is claimed is:

1. A system for monitoring the attention of a user, comprising
a display;
an eyetracker that measures a user's gazepoint within the display; and
a processor in communication with the display and the eyetracker that
displays one or more images to the user on the display;
determines that an image of the one or more images is being viewed by an eye of the user from one or more measurements received from the eyetracker;
displays one or more modifications to the image on the display over time so as to maintain the attention of the user; and
determines if the attention of the user is maintained from one or more additional measurements received from the eyetracker after the one or more modifications to the image.

2. The system of claim 1, wherein the processor determines that an image of the one or more images is being viewed by an eye of the user from one or more measurements received from the eyetracker by receiving from the eyetracker a first gazepoint of the eye on the display and calculating the image that includes the first gazepoint.

3. The system of claim 2, wherein the processor displays one or more modifications to the image on the display over time so as to maintain the attention of the user by displaying the image at a new location on the display so that the image does not include the location of the first gazepoint.

4. The system of claim 2, wherein the processor determines if the attention of the user is maintained from one or more additional measurements received from the eyetracker after the one or more modifications to the image by receiving from the eyetracker a second gazepoint of the eye on the display after the image is modified and calculating if image includes the second gazepoint.

5. The system of claim 1, wherein the processor displays one or more modifications to the image on the display over time so as to maintain the attention of the user by animating the image on the display.

6. The system of claim 5, wherein the processor further increases the activity of the animation if the attention of the user is maintained.

7. The system of claim 5, wherein the processor further decreases the activity of the animation if the attention of the user is not maintained.

8. The system of claim 1, wherein the processor displays one or more modifications to the image on the display over time so as to maintain the attention of the user by increasing the complexity of the image on the display.

9. The system of claim 1, wherein the one or more modifications comprise at least two modifications.

10. The system of claim 1, wherein the processor displays another modification to the image on the display that encourages a response from an input device after the one or more modifications and determines that the user's attention is maintained, if the response from the input device is received.

11. The system of claim 10, wherein the input device comprises a keyboard, a mouse, a head point, a finger pointer, or a microphone.

12. The system of claim 1, wherein the image is a character with one or more eyes.

13. The system of claim 1, wherein the image is an eye of a character with one or more eyes.

14. The system of claim 13, wherein the processor displays one or more modifications to the image on the display over time so as to maintain the attention of the user by displaying the eye of the character as making eye contact with the eye of the user.

15. The system of claim 1, further comprising a second display that allows a teacher to monitor activities of the display and the eyetracker.

16. The system of claim 15, further comprising an input device that allows the teacher to modify the image.

17. The system of claim 1, further comprising a memory in communication with the processor that the processor uses to record the one or modifications, the one or more measurements, the one or more additional measurements, and a rate of presentation of the one or modifications to the user.

18. The system of claim 17, wherein the processor displays the one or more modification to the user based on a rate of presentation previously stored in the memory.

19. A method for monitoring the attention of a user, comprising displaying one or more images to a user on a display;
determining that an image of the one or more images is being viewed by an eye of the user from one or more measurements received from an eyetracker;
displaying one or more modifications to the image on the display over time so as to maintain the attention of the user; and
determining if the attention of the user is maintained from one or more additional measurements received from the eyetracker after the one or more modifications to the image.

20. A computer program product, comprising a tangible computer-readable storage medium whose contents include a program with instructions being executed on a processor so as to perform a method for monitoring the attention of a user, the method comprising:
providing a system, wherein the system comprises distinct software modules, and wherein the distinct software modules comprise a display module and as eyetracking module;
displaying one or more images to a user on a display using the display module;
determining that an image of the one or more images is being viewed by an eye of the user from one or more measurements received from an eyetracker using the eyetracking module;
displaying one or more modifications to the image on the display over time so as to maintain the attention of the user using the display module; and
determining if the attention of the user is maintained from one or more additional measurements received from the eyetracker after the one or more modifications to the image using the eyetracking module.
